(19) United States
(12) Patent Application Publication
(10) Pub. No.: US 2012/0047529 A1
(43) Pub. Date: Feb. 23, 2012

(54) TELEVISION AND SOCIAL NETWORK INTERWORKING SYSTEM AND METHOD

(76) Inventors: Jennifer Schultz, Johns Creek, GA (US); Charles Dasher, Lawrenceville, GA (US)

(21) Appl. No.: 12/860,145

(22) Filed: Aug. 20, 2010

(51) Int. Cl. H04N 7/025

(52) U.S. Cl. 725/34

(57) ABSTRACT

An integrated television delivery and social networking system for improving service to a user. A television delivery system delivers television programs and advertisements to the user, and a social network website enables the user to post social updates for the user's friends and to receive social updates from the friends. An interworking unit interworks between the television delivery system and the social network website. The interworking unit obtains information from the television delivery system or the social network website and automatically provides the information from one to the other. The system may automatically post to the website, an indication of what television program the user is watching; may display to the user how many of his friends liked the television program or advertisement the user is watching; and may use user interests in the user's social network profile to select targeted television advertisements to present to the user.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to networking and communication systems. More particularly, and not by way of limitation, the present invention is directed to a system and method for interworking between a television delivery system and a social networking website.

Consumers increasingly post their daily activities and interests to a variety of social networking websites. Oftentimes, these messages and updates serve dual purposes: they keep friends up to date on the user's activities, and they also provide information on the user's interests as well as the user's likes, and dislikes with regard to things such as movies, books, products, and the like. Automated social networking updates also exist for web applications such as web video, web sites, or web music. An example is a video-sharing website having the option to automatically post comments to a social networking website about a video a user enjoyed, thus sharing this interest/opinion and this video with all the user's friends (while providing free, automated advertising for the video).

Increasingly, social networking websites have released information regarding users (such as things they like, or their friends like) to third parties for the purpose of providing a recommendation for a particular website, article, video, and so on. Current technologies taking advantage of social networks, however, are generally limited to traditional Internet technologies. For example, a website may mention that your friends enjoy it, but this information will not appear in other types of communication media.

In another communication medium, television, advertisers want to make sure people are paying attention to their advertisements. Advertisers often use celebrity endorsements, as a means of getting people to judge their products as more relevant. Celebrity endorsements, however, often lack a personal touch, with modern viewers caring more about the opinions of friends rather than the opinion of a celebrity.

Advertisers also employ a variety of methods for targeting advertisements to viewers. Targeted ads are generally thought to be more engaging or interesting to a viewer than non-targeted ads. Existing solutions, however, rely on demographic information such as age, gender, location, and the like to display advertisements that a given viewer is likely to be interested in. These solutions are limited since only educated guesses can be made about a viewer's actual interests.

### SUMMARY

The present invention is directed to a system and method for interworking between a television delivery system and a social networking website. In one embodiment, the interworking system recognizes what television program a user is watching and automatically posts this information to the user's social networking website. Automatic posting of social networking updates benefits users by providing constant updates, while relieving the user of the burden of having to personally write all of the updates. In an increasingly connected world, social media allows ‘grassroots’ movements in support of individual causes or interests. Such movements are further strengthened (and leveraged) when television providers provide automatic social updates for their customers. The automatic social updates also provide free advertising to television content providers since viewers are more likely to watch something they know their friends are also watching.

In another embodiment, the interworking system retrieves user interests and/or preferences from the social network website and provides them to an advertising system for purposes of providing targeted advertisements to the user. By cross-referencing the users interests and/or preferences with potential advertisements in a television delivery system such as a cable television system, better targeted advertisements are provided to particular viewers. Taking the guesswork out of targeted advertisements benefits viewers because they see advertisements of genuine interest to them. Additionally, should they find advertisements that do not suit their taste, they have a predefined, easy way to change their interests (via their existing social networking profile) to alter the advertisements they see.

In another embodiment, the interworking system retrieves ratings posted by a user's friends regarding television content or advertisements that the friends have viewed. The ratings are then displayed to the user along with the television content or advertisements. For example, while watching an advertisement, the user may see a message stating that X number of his friends liked the advertisement. This enables users to better judge the relevance of given products, while simultaneously allowing advertisers to better endorse their products.

Thus, in one embodiment, the present invention is directed to a computer-controlled method of interworking between a television delivery system and a social network website to improve service to a user. The method includes the steps of obtaining by an interworking unit, information from the television delivery system or the social network website; and automatically providing information from the television delivery system to the social network website, or providing information from the social network website to the television delivery system.

In another embodiment, the present invention is directed to a computer-controlled interworking unit for interworking between a television delivery system and a social network website to improve service to a user. The interworking unit includes means for obtaining information from the television delivery system or the social network website; and means for automatically providing information from the television delivery system to the social network website, or providing information from the social network website to the television delivery system.

In another embodiment, the invention is directed to an integrated television delivery and social networking system for improving service to a user. The system includes a television delivery system for delivering television programs and advertisements to the user; a social network website for enabling the user to post social updates for the user's friends and to receive social updates from the friends; and a computer-controlled interworking unit for interworking between the television delivery system and the social network website. The interworking unit includes means for obtaining information from the television delivery system or the social network website; and means for automatically providing information from the television delivery system to the social network website, or providing information from the social network website to the television delivery system.

### BRIEF DESCRIPTION OF THE DRAWINGS

In the following section, the invention will be described with reference to exemplary embodiments illustrated in the figures, in which:

FIG. 1 is a simplified block diagram of an exemplary embodiment of the interworking system of the present invention;

FIG. 2 is a flow chart of an exemplary embodiment of a first method performed by the interworking system of FIG. 1;

FIG. 3 is a flow chart of an exemplary embodiment of a second method performed by the interworking system of FIG. 1; and

FIG. 4 is a flow chart of an exemplary embodiment of a third method performed by the interworking system of FIG. 1.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

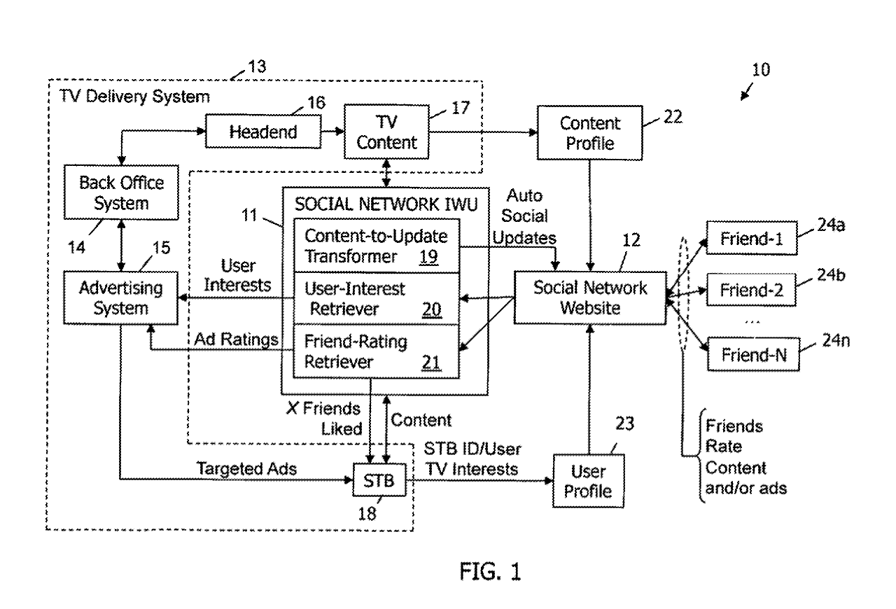

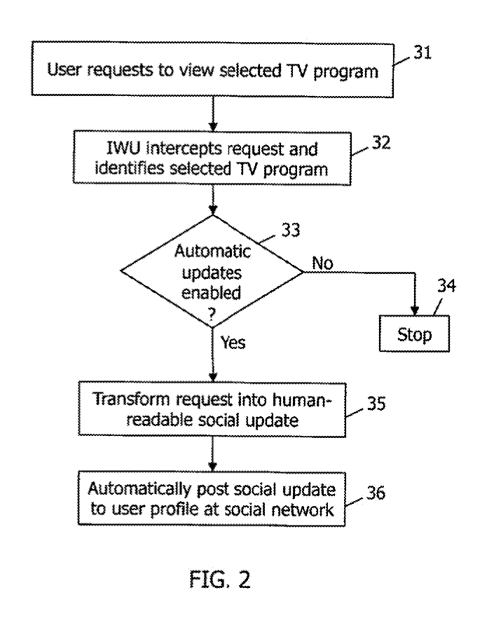

FIG. 1 is a simplified block diagram of an exemplary embodiment of the interworking system 10 of the present invention. A social network interworking unit (IWU) 11 interfaces a social network website 12 with a television (TV) delivery system 13. In various configurations, the TV delivery system may include a back office system 14, an advertising system 15, and in the case of a cable TV system, a headend 16 for providing TV content 17 to a user via a set top box (STB) 18. Within the social network IWU, there is a content-to-update transformer 19, a user-interest retriever 20, and a friend-rating retriever 21. Operation of these components is described below in connection with FIGS. 2-4.

It should be understood that although the social network IWU 11 is illustrated as a separate, standalone unit, it may also be distributed between the social network website 12 and the TV delivery system 13. Alternatively, the social network IWU may be implemented in one or more of the existing components of the TV delivery system such as the back office system 14, the advertising system 15, or the headend 16. It is also to be understood that operation of the social network IWU may be controlled by one or more microprocessors executing computer program instructions stored in one or more memory units. Alternatively, the social network IWU may be implemented in hardware, firmware, or a combination of software, hardware, and firmware.

The TV delivery system 13 posts a content profile 22 of the TV content 17 to the social network website 12. Likewise, the STB 18 posts a set top box identifier (STB ID) and TV interests of the user to the social network website in a user profile 23. The social network website is then able to correlate TV programs and advertisements with the STB and the user interests. In addition, friends 24a-24n may post their interests as well as their ratings of the TV content and advertisements they have viewed to the social network website.

With continuing reference to FIG. 1, the operation of the interworking system will now be described with additional reference to FIGS. 2-4.

FIG. 2 is a flow chart of an exemplary embodiment of a first method performed by the interworking system 10 of FIG. 1. In this method, the interworking system recognizes what television program a user is watching and automatically posts this information to the user's social networking website. At step 31, a user requests to view a selected broadcast or video-on-demand (VOD) program from the TV delivery system 13. At step 32, the social network IWU 11 intercepts the request and identifies the requested program. At step 33, the social network IWU determines whether the user has enabled automatic social updates. The user may enable or disable automatic updates through the user profile at the social network website 12, or for more modern STBs or connected televisions, this may be done through a dedicated button on the STB or television. If automatic social updates are not enabled, the method stops at step 34. However, if automatic social updates are enabled, the method moves to step 35 where the content-to-update transformer 19 transforms the user's request into a human-readable social update. At step 36, the social network IWU automatically posts the update to the user's profile at the social network website. For example, if the user is watching a particular television show such as “The Jetsons”, the user's twitter feed may automatically update (through no human intervention) with “am watching ‘The Jetsons’ at 7:00”. If the user is frequently changing channels, the twitter feed may automatically update “Channel surfing”.

For legacy STBs, interception circuitry and interpretation logic may be implemented at the headend 16 or back office system 14. More modern STBs may be done the same way, but are not as restricted to do so. In the case of VOD, it is simple to discover what is being watched, when it is being watched, and who is watching it (based on STB ID). This information is then parsed to human-readable format, and sent via Internet Protocol to the user's social network page (logged in as that particular user). For broadcast, the program being watched may be determined by detecting what channel the STB is tuned to based on frequency, the time of day, and by cross referencing TV guide or program ID data. Individual STBs can be associated (for legacy systems) on the cable provider's web page. For more modern, two-way systems, profiles can be created directly via the STB, although web page systems can also be utilized.

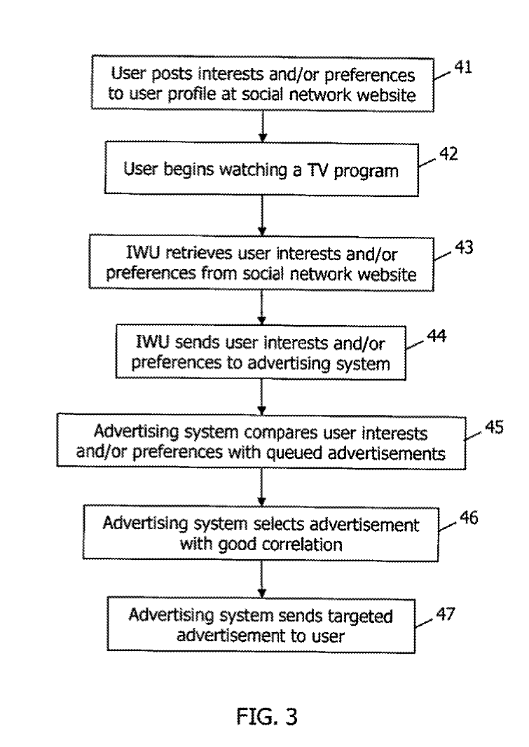

FIG. 3 is a flow chart of an exemplary embodiment of a second method performed by the interworking system 10 of FIG. 1. In this method, the interworking system retrieves user interests and/or preferences from the social network website 12 and provides them to the advertising system 15 for purposes of providing targeted advertisements to the user. At step 41, the user posts interests and/or preferences to his user profile at the social network website. At step 42, which may be at a later time, the user begins watching a TV program. At step 43, the user-interest retriever 20 in the social network IWU 11 retrieves the interests and/or preferences from the user profile at the social network website. At step 44, the social network IWU sends the retrieved interests and/or preferences to the advertising system 15. At step 45, the advertising system compares the retrieved interests and/or preferences with queued advertisements, and at step 46 selects a targeted advertisement for which there is good correlation with the user's interests and/or preferences. The selection may be made, for example, by selecting the advertisement for which the most interests of the user match a label of the advertisement. At step 47, the advertising system sends the targeted advertisement to the user during the next advertising time slot.

Since members of social networking websites have already, quite explicitly spelled out their interests and/or preferences via social networking profiles, the information is more powerful than demographics. A given STB can be associated with a social networking profile, complete with access to information on interests and likes versus dislikes. All advertisements in the TV delivery system may be labeled by their content (for example “Biking”). When an advertising slot arrives, the invention selects advertisements that most closely correlate with the associated profile's likes. For example, a profile that indicates an interest in biking or racing will trigger more advertisements for these types of products or services. Other personal information (if posted to the profile and provided by the social networking site) may also be provided to the advertising system. For example, a person's relationship status is often a profile component of a given social networking website. When this information is provided to the advertising system, a user who recently became engaged may be shown more diamond commercials, whereas a user who recently became single may be shown more dating website commercials, and so on.

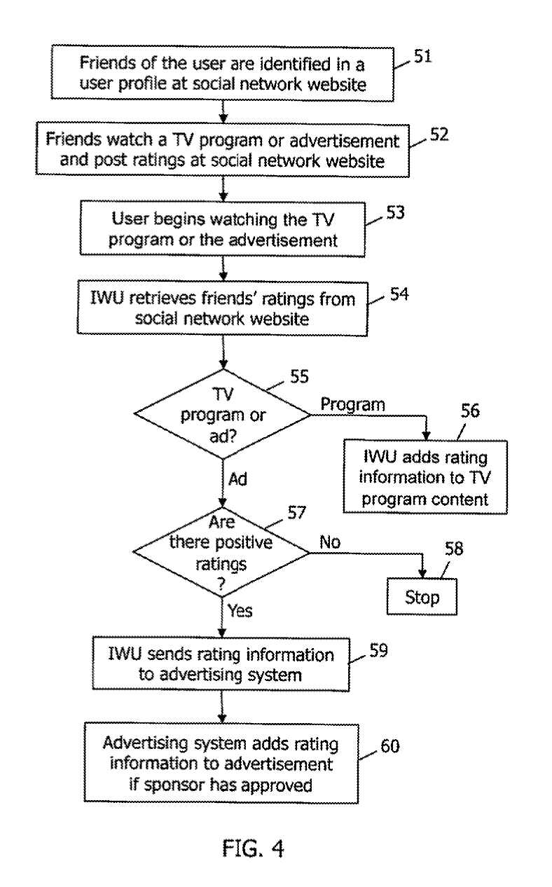

FIG. 4 is a flow chart of an exemplary embodiment of a third method performed by the interworking system 10 of FIG. 1. In this method, the interworking system retrieves ratings posted by a user's friends regarding television content or advertisements that the friends have viewed. The ratings are then displayed to the user along with the television content or advertisements. At step 51, a number of the user's friends are identified in the user profile at the social network website 12. At step 52, the friends watch a TV program or advertisement and post ratings at the social network website. At step 53, the user begins watching the TV program or the advertisement. At step 54, the friend-rating retriever 21 in the social network IWU retrieves the friends' ratings from the social network website.

At step 55, the method splits, depending upon whether the rating information relates to a television program or an advertisement. If the rating information relates to a television program, the method moves to step 56 where the rating information is added to the program content and is displayed to the user along with the video feed (such as “7 of your friends like this”, or similar).

However, if the rating information relates to an advertisement, the method moves to step 57 where it is determined whether there are any positive ratings in the friends' ratings. If not, the method optionally moves to step 58 and stops. In this way, the method proceeds only if the ratings are positive (i.e., the system does not display that no one liked a given product). If there are positive ratings, the method moves instead to step 59 where the social network IWU sends the rating information to the advertising system 15. At step 60, the advertising system adds the rating information to the advertisement if the sponsor has approved.

Cable STBs can be associated with a particular social networking profile. Advertisements stored in the cable headend 16 may also be linked with existing social networking equivalents (which generally includes a list of those ‘liking’ it). As an advertisement is played (via VOD or broadcast), the STB is cross-referenced and the social networking application itself returns how many people are both friends of the STB user and have viewed and rated the advertisement shown. This information is then included with the video feed, and displayed to the user.

It should also be noted that if a majority of the user's friends rate a given advertisement particularly high, the social network website 12 may send an indication of this fact to the social network IWU 11. The social network IWU, in turn, may send this indication to the advertising system 15. The advertising system may then select the given advertisement for showing to the user since there is a high likelihood that if the user's friends liked it, the user will, too.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A computer-controlled method of interworking between a television delivery system and a social network website to improve service to a user, the method comprising the steps of:
obtaining by an interworking unit, information from the television delivery system or the social network website; and
automatically providing information from the television delivery system to the social network website, or providing information from the social network website to the television delivery system.

2. The method according to claim 1, wherein:
the step of obtaining information includes obtaining by the interworking unit, information from the television delivery system regarding a television program being viewed by the user; and
the step of automatically providing information includes automatically posting to the social network website, an indication that the user is viewing the television program.

3. The method according to claim 2, further comprising posting by the interworking unit to the social network website, a rating that the user applies to the program.

4. The method according to claim 1, wherein the social network website includes a user profile for the user, the user profile including identities of friends of the user, and the method further comprises the steps of:
posting by the interworking unit to the social network website, a rating that each friend of the user has applied to an identified television program or advertisement;
detecting by the interworking unit that the user has started to view the identified television program or advertisement;
obtaining by the interworking unit from the social network website, the ratings applied to the identified television program or advertisement by the friends of the user; and
displaying to the user, the information regarding the ratings applied to the identified television program or advertisement by the friends of the user.

5. The method according to claim 4, wherein an advertisement is rated, and the displaying step is performed only when the ratings applied to the identified television advertisement are positive.

6. The method according to claim 1, wherein the social network website includes a user profile for the user, the user profile including identities of friends of the user, and the method further comprises the steps of:
posting by the interworking unit to the social network website, a rating that each friend of the user has applied to an identified television advertisement;
determining by the social network website, that a majority of the user's friends have rated the identified advertisement positively;
sending from the social network website to the interworking unit, an indication that a majority of the user's friends have rated the identified advertisement positively;
sending the indication from the interworking unit to an advertising system associated with the television delivery system; and
selecting the identified advertisement by the advertising system for showing to the user.

7. The method according to claim 1, wherein the social network website includes a user profile for the user, the user profile including interests of the user, and the method further comprises the steps of:
retrieving the user interests from the social network website by the interworking unit;
sending the user interests from the interworking unit to an advertising system associated with the television delivery system; and
utilizing the user interests by the advertising system to select targeted advertisements to show to the user.

8. A computer-controlled interworking unit for interworking between a television delivery system and a social network website to improve service to a user, the interworking unit comprising:
means for obtaining information from the television delivery system or the social network website; and
means for automatically providing information from the television delivery system to the social network website, or providing information from the social network website to the television delivery system.

9. The interworking unit according to claim 8, wherein:
the means for obtaining information includes means for obtaining information from the television delivery system regarding a television program being viewed by the user; and
the means for automatically providing information includes a content-to-update transformer for automatically posting to the social network website, an indication that the user is viewing the television program.

10. The interworking unit according to claim 9, further comprising means for posting to the social network website, a rating that the user applies to the program.

11. The interworking unit according to claim 8, wherein the social network website includes a user profile for the user, the user profile including identities of friends of the user, and the interworking unit further comprises:
means for posting to the social network website, a rating that each friend of the user has applied to an identified television program or advertisement;
means for detecting that the user has started to view the identified television program or advertisement;
a friend-rating retriever for retrieving from the social network website, the ratings applied to the identified television program or advertisement by the friends of the user; and
means for sending the ratings to the TV delivery system for displaying to the user.

12. The interworking unit according to claim 11, wherein an advertisement is rated, and the means for sending the ratings to the TV delivery system sends the ratings only when the ratings applied to the identified television advertisement are positive.

13. The interworking unit according to claim 8, wherein the social network website includes a user profile for the user, the user profile including identities of friends of the user, and the interworking unit further comprises:
means for posting to the social network website, a rating that each friend of the user has applied to an identified television advertisement; and
means for sending an indication to an advertising system associated with the television delivery system indicating the number of friends who have rated the identified advertisement positively, when a majority of the user's friends have rated the identified advertisement positively;
wherein the advertising system selects the identified advertisement for showing to the user.

14. The interworking unit according to claim 8, wherein the social network website includes a user profile for the user, the user profile including interests of the user, and the interworking unit further comprises:
a user-interest retriever for retrieving the user interests from the social network website;
means for sending the user interests to an advertising system associated with the television delivery system for use by the advertising system in selecting targeted advertisements to show to the user.

15. An integrated television delivery and social networking system for improving service to a user, the system comprising:
a television delivery system for delivering television programs and advertisements to the user;
a social network website for enabling the user to post social updates for the user's friends and to receive social updates from the friends; and
a computer-controlled interworking unit for interworking between the television delivery system and the social network website, the interworking unit comprising:
means for obtaining information from the television delivery system or the social network website; and
means for automatically providing information from the television delivery system to the social network website, or providing information from the social network website to the television delivery system.

16. The system according to claim 15, wherein:
the means for obtaining information includes means for obtaining information from the television delivery system regarding a television program being viewed by the user; and
the means for automatically providing information includes a content-to-update transformer for automatically posting to the social network website, a human-readable indication that the user is viewing the television program.

17. The system according to claim 15, wherein the social network website includes a user profile for the user, the user profile including identities of friends of the user, and the interworking unit also includes:
means for posting to the social network website, a rating that each friend of the user has applied to an identified television program or advertisement;
means for detecting that the user has started to view the identified television program or advertisement;
a friend-rating retriever for retrieving from the social network website, the ratings applied to the identified television program or advertisement by the friends of the user; and
means for sending the ratings to the TV delivery system for displaying to the user.

18. The system according to claim 17, wherein an advertisement is rated, and the means for sending the ratings to the TV delivery system sends the ratings only when the ratings applied to the identified television advertisement are positive.

19. The system according to claim 15, wherein the social network website includes a user profile for the user, the user profile including identities of friends of the user, and the interworking unit also includes:
means for posting to the social network website, a rating that each friend of the user has applied to an identified television advertisement; and
means for sending an indication to an advertising system associated with the television delivery system indicating the number of friends who have rated the identified advertisement positively when a majority of the user's friends have rated the identified advertisement positively;
wherein the advertising system selects the identified advertisement for showing to the user.

20. The system according to claim 15, wherein the social network website includes a user profile for the user, the user profile including interests of the user, and the interworking unit also includes:
a user-interest retriever for retrieving the user interests from the social network website; and
means for sending the user interests to an advertising system associated with the television delivery system for use by the advertising system in selecting targeted advertisements to show to the user.
